(19) United States
(12) Patent Application Publication
(10) Pub. No.: US 2010/0066058 A1
(43) Pub. Date: Mar. 18, 2010

(54) All terrain stroller

(76) Inventors: Barbara Norcia, Port St. Lucie, FL (US); James Norcia, Port St. Lucie, FL (US)

Correspondence Address: TED PAULDING, 10 PENWOOD LANE, WETHERSFIELD, CT, 06109, US

(21) Appl. No.: 12/283,800

(22) Filed: Sep. 16, 2008

(51) Int. Cl. B62B 7/06

(52) U.S. Cl. 280/642

(57) ABSTRACT

An all terrain stroller has front, rear and intermediate frame members, a baby seat on the frame, and a pair of vertically movable wheels on the front frame member. Two rollers are mounted respectively on the front and rear frame members for travel over soft terrain, and the rear frame member also carries a pair of wheels at opposite ends of the roller with a diameter slightly larger than that of the roller. A foot operable mechanism raises and lowers the pair of movable wheels to engage a hard surface and raise the adjacent roller above the surface and selectively to lower the roller onto a soft surface.

### BACKGROUND OF THE INVENTION

This invention relates to baby strollers, and more particularly, to baby strollers designed for selective use on hard surfaces such as floors and sidewalks and also on soft surfaces such as sand, bare dirt, and grass.

U.S. Pat. No. 5,158,319 entitled ALL TERRAIN BABY CARRIAGE, issued Oct. 27, 1992 to Barbara and James Norcia, hereby incorporated herein by reference, discloses a carriage or stroller with selectively usable rollers for soft surfaces and conventional wheels for hard surfaces and represents a significant advance in the art. The rollers of the patent however, are provided with gear like ribs found to be unnecessary and in fact detrimental in collecting dirt, grass and other debris in use. Provision of the gear like ribs also adds significantly to manufacturing cost. Further, a hand operated mechanism for raising and lowering the wheels which elevate at least one roller can be unecessarily complex, unwieldy and awkward in use.

In view of the foregoing, it is the general object of the present invention to provide an improved all terrain stroller eliminating the gear like ribs on the rollers and substituting a simple yet effective and easy to operate foot pressure mechanism for raising and lowering the wheels which convert from hard to soft surface operation.

### SUMMARY OF THE INVENTION

In fulfillment of the aforementioned object and in accordance with the present invention, an all terrain stroller is provided with front, rear and intermediate frame members, a seat for supporting a baby, a wheel assembly including at least one and preferably a pair of vertically movable wheels for selective travel over hard and soft surfaces, at least two transversely extending smooth surface rollers respectively mounted on said front and rear frame members for efficient travel over soft terrain, the aforesaid wheels projecting slightly below one of said rollers in their lower position whereby to elevate the roller above a hard surface, and a lever mechanism operable by foot pressure to raise and lower said wheels.

The stroller is also provided with a handle for pushing the same and the handle and all frame members are hingedly interconnected to permit the stroller to collapse for storage.

A pair of wheels mounted respectively at opposite ends of the roller on the front frame member are operable in both modes i.e, hard and soft surface operation. The are preferably approximately one inch larger in diameter than the roller.

### DESCRIPTION OF THE DRAWINGS

FIG. 1 is a side view in elevation of the stroller of the invention in its hard surface mode of operation,

FIG. 2 is a front view of the stroller also in its hard surface mode,

FIG. 3 is a fragmentary rear view showing the rear roller and associated wheels carried by the rear frame member,

FIG. 4 is an enlarged fragmentary side view showing a lower portion of the stroller in its soft surface mode,

FIG. 5 is an enlarged view similar to FIG. 4 but showing the stroller in its hard surface mode, and

FIG. 5A is an enlarged fragmentary view showing a latch mechanism for securing the stroller in a hard surface mode of operation.

### DESCRIPTION OF THE PREFERRED EMBODIMENTS

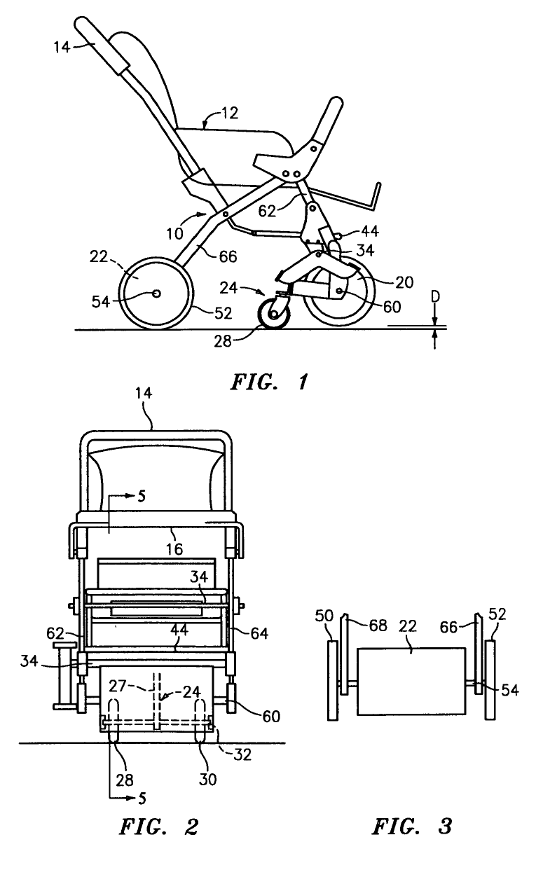

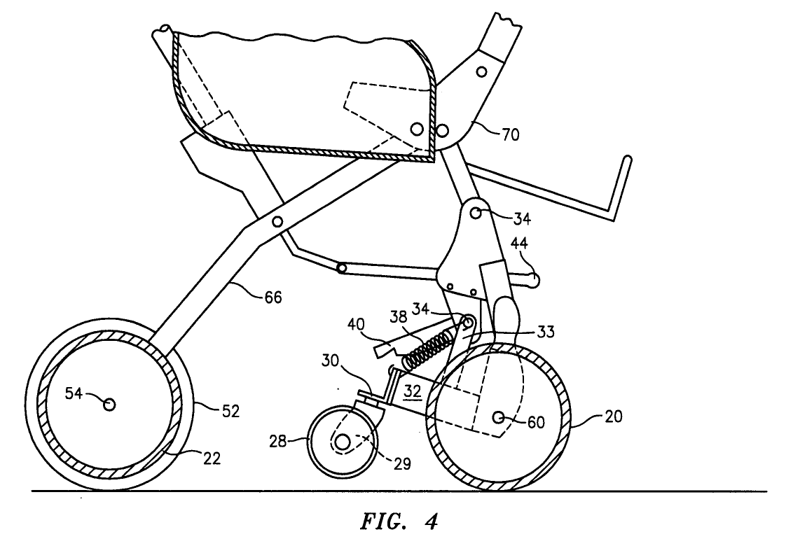

Referring particularly to FIG. 1, a frame of the improved stroller is indicated generally at 10, a seat for supporting a baby at 12, and a handle for pushing the stroller at 14.

Front and rear rollers 20 and 22 have smooth easily maintained surfaces throughout and are particularly well adapted to use on soft and irregular surfaces due to their large diameter and particularly their substantial length.

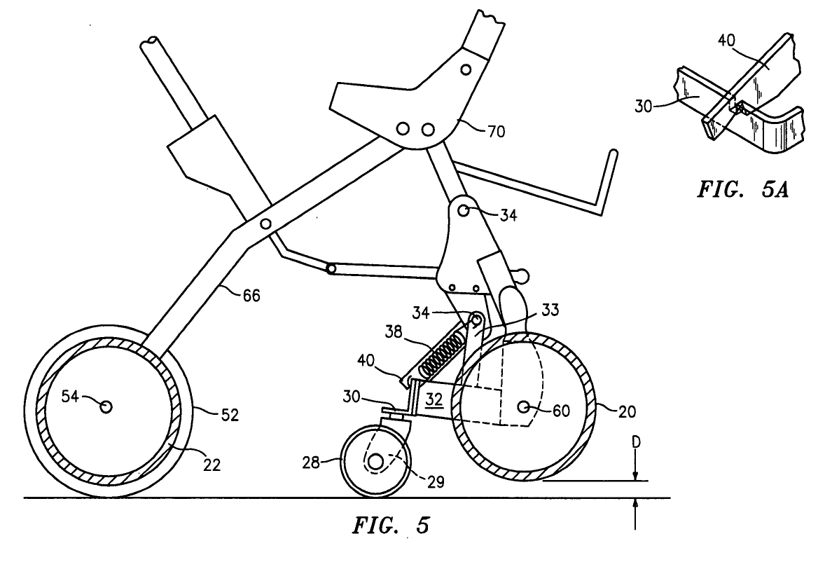

Intermediate the rollers 20,22, a wheel assembly indicated generally at 24 includes a pair of transversely spaced wheels 28,28 which are mounted on a transverse bracket member 30 supported at opposite ends by short arms 32,32 for ease in steering the stroller. Links 33,33 fix the arms 32,32 to a pivot shaft 34 which extends transversely and which has a double ended lever 36 fixed thereto and exposed at one end for convenient operation by the foot of an adult using the stroller. The shaft 34 is pivotally mounted at opposite ends in brackets 35,35 in turn supported by a front frame member 62. As will be obvious, foot pressure on the lever 36 will cause the shaft 34 to pivot and swing the arms 32,32 and bracket member 30 in one and an opposite direction raising and lowering the wheels 28,28. The bracket and wheels are biased toward their upper position by a spring 38 and a latch element 40, FIG. 5A, retains the wheels in the lower position for efficient hard surface operation. Slight clockwise foot pressure on the lever 36 releases the latch allowing the spring 38 to pivot the wheels to their upper position whereas somewhat heavier counter-clockwise pressure lowers the wheels and engages the latch 40.

Left and right hand front frame members 62,62 also support the aforementioned roller 20 on a shaft 60 carried at opposite ends by transversely spaced lower portions of the frame members. Left and right hand Intermediate frame members 44,44 also have front end portions hingedly connected to a front frame member. The members are in two sections hingedly interconnected with rear sections hingedly connected to the rear frame members 66,66. The handle 14 is also hingedly connected to the rear frame members so that the entire stroller is completely collapsible for storage.

In accordance with another aspect of the invention, a pair of wheels 52,52 are mounted coaxially with the rear roller 22 on a shaft 54 as best seen in FIG. 3. The wheels 52,52 are slightly larger than the roller with a diameter approximately one inch greater than that of the roller. As will be apparent, the wheels are operative on a hard surface raising the roller above the surface. On a soft surface such as sand the wheels tend to sink slightly below the surface allowing the roller to bear the weight of the stroller and baby for efficient travel over the surface.

From the foregoing it will be apparent that the general object set forth above has been fully satisfied and an improved all terrain stroller both efficient in use and durable over a long service life has been provided. Further, the stroller can be manufactured at economic advantage.

1. An all terrain stroller comprising a frame including front and rear members, a seat for supporting a baby carried by the frame, a wheel assembly including at least one vertically movable wheel for selective travel over hard and soft surfaces mounted on one of said frame members, at least two transversely extending elongated rollers having substantially smooth surfaces mounted respectively on the front and rear frame members for efficient travel over soft terrain, the aforesaid movable wheel projecting at least partially below one of said rollers in a lower position whereby to elevate the roller out of contact with a hard surface, and a lever mechanism operable by foot pressure to raise and lower the movable wheel.

2. An all terrain stroller as set forth in claim 1 wherein the frame also includes a handle connected to the rear frame member for pushing the stroller, the front and rear frame members and the handle all being hingedly interconnected to permit the stroller to collapse for storage.

3. An all terrain stroller as set forth in claim 1 wherein a latch element is provided for securing said wheel in its lower position.

4. An all terrain stroller as set forth in claim 1 wherein a pair of vertically movable wheels are provided each pivotally mounted on said front frame member for ease in steering.

5. An all terrain stroller as set forth in claim 1 wherein the intermediate frame member is hingedly connected between the front and rear frame members.

6. An all trerrain stroller as se forth in claim 1 wherein a pair of transversly spaced wheels are mounted on the rear frame member respectively at opposite ends of the rear roller, the diameter of the wheels being slightly larger than that of the roller to elevate the same and provide for efficient travel on a hard surface.

7. An all terrain stroller as set forth in claim 6 wherein the wheels are approximately one inch larger than the roller in diameter.
